(19) United States
(12) Patent Application Publication
(10) Pub. No.: US 2007/0220951 A1
(43) Pub. Date: Sep. 27, 2007

(54) Method and Apparatus for Detecting the Type of Anesthetic Gas

(76) Inventors: Huiling Zhou, Shenzhen (CN); Wei Zhang, Shenzhen (CN); Zhigang Wu, Shenzhen (CN)

Correspondence Address: PILLSBURY WINTHROP SHAW PITTMAN LLP, P.O. BOX 10500, MCLEAN, VA, 22102, US

(21) Appl. No.: 11/615,839

(22) Filed: Dec. 22, 2006

(30) Foreign Application Priority Data
Mar. 21, 2006 (CN) 200610034618.5

(51) Int. Cl. G01N 7/00; G01N 30/02

(52) U.S. Cl. 73/23.2; 73/23.35

(57) ABSTRACT

Disclosed is a method and apparatus for detecting the type of anesthetic gas. The method comprises the steps of: passing a plurality of light beams through a gas chamber injected with said anesthetic gas, wherein, said anesthetic gas has respective absorption characteristic with respect to each light beam; detecting the light intensities of the attenuated light beams absorbed by the anesthetic gas, respectively, to obtain the relative absorption coefficients of one of the attenuated light beams with respect to the others; mapping the obtained relative absorption coefficients into a coordinate system, which corresponds to said relative absorption coefficients; and determining the type of said anesthetic gas based on the mapping position of said relative absorption coefficients in the coordinate system.

### FIELD OF THE INVENTION

The invention relates to a method and apparatus for detecting the type of gas, and more particularly, to a method and apparatus for detecting the type of anesthetic gas.

### BACKGROUND OF THE INVENTION

In certain medical fields, anesthetic gases are commonly used in anaesthesia surgery. With respect to different kinds of anesthetic gases, different concentrations must be adopted to meet the requirements of the clinical medicine, based on the age and the physical condition of the patient.

In the commonly used anesthetic instruments, the type of the anesthetic gas is generally manually inputted by the anesthetist, and the operation is extremely inconvenient. In recent years, attempts are being made to propose a practical method and apparatus for automatically identifying the type of anesthetic gas with high accuracy.

The measuring principle of the conventional method for identifying the type of anesthetic gases is generally based on the Non-dispersive Infrared (NDIR) technique. That is, by utilizing the characteristic that a certain gas exhibits specific absorption effect with respect to the infrared lights of a certain wave band and passing infrared light waves of the wave band through gas sample to be detected, the type of the anesthetic gas is determined by solving a matrix equation utilizing the theory that the attenuated amount of the transmissive lights and the concentration of the gas to be detected satisfy the Beer-Lambert law.

However, the infrared absorption spectrums of commonly used anesthetic gases in clinical medicine (i.e. Desflurane, Isoflurane, Halothane, Sevoflurane, Enflurane) concentrate within a wide range of 7-14 μm and overlap with each other. Moreover, the Beer-Lambert law is applicable to monochromatic light. In practice, however, the infrared lights filtered by light filters from the infrared light source generally have a certain bandwidth.

Therefore, the above-mentioned matrix equation will become a non-linear matrix equation when the type of the gas to be detected is determined by utilizing the Beer-Lambert law, which makes the solving procedure extremely complicated.

Although the non-linear matrix equation can be simplified by performing a particular design with respect to the parameters of light filters (see U.S. Pat. Nos. 5,046,018, 5,231,591), the designing and the manufacturing process for the light filters are of great complexity, resulting a rise in the cost of the apparatus for detecting anesthetic gases utilizing the light filters.

### SUMMARY OF THE INVENTION

A broad and general object of the present invention is to provide a method and apparatus capable of determining the type of anesthetic gas automatically. With this method and apparatus, the type of the anesthetic gas can be simply determined. Further advantage of the method and apparatus is that the complexity is low and the cost is reduced.

A method for detecting the type of anesthetic gas according to the present invention comprises the steps of passing a plurality of light beams through a gas chamber injected with said anesthetic gas, wherein, said anesthetic gas has respective absorption characteristic with respect to each light beam; detecting the light intensities of the attenuated light beams absorbed by the anesthetic gas, respectively, to obtain the relative absorption coefficients of one of the attenuated light beams with respect to the others; mapping the obtained relative absorption coefficients into a coordinate system, which corresponds to said relative absorption coefficients; and determining the type of said anesthetic gas based on the mapping position of said relative absorption coefficients in the coordinate system.

An apparatus for detecting the type of anesthetic gas according to the present invention, comprises a gas chamber, to which said anesthetic gas is injected, wherein, said anesthetic gas have absorption characteristic with respect to each of said plurality of light beams having passed through said gas chamber; a detecting unit, operative to detect the light intensities of the attenuated light beams transmitted through the gas chamber and absorbed by the anesthetic gas, respectively, to obtain the relative absorption coefficients of one of the attenuated light beams with respect to the others; a mapping unit, operative to map the obtained relative absorption coefficients into a coordinate system, which corresponds to said relative absorption coefficients; and a determining unit, operative to determine the type of said anesthetic gas based on the mapping position of said relative absorption coefficients.

Other objects and results of the present invention will become more apparent and will be easily understood with reference to the description made in combination with the accompanying drawings.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic view of the configuration of an apparatus for detecting the type of anesthetic gas according to a preferred embodiment of the invention.

FIG. 2 shows a schematic view of the infrared absorption spectrum of various gases in the embodiment of the present invention.

FIG. 3 is a schematic view of a two-dimensional relative absorption coefficient coordinate system adopted in the preferred embodiment of the invention.

FIG. 4 is a flowchart of a method for detecting the type of anesthetic gas according to the preferred embodiment of the invention.

The same reference signs in the figures indicate similar or corresponding feature and/or functionality.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The method for detecting the type of anesthetic gas according to the present invention is realized in that: in view of the characteristic that an anesthetic gas exhibits specific absorption effect with respect to infrared lights of different wavelengths, passing the infrared lights through the anesthetic gas to be detected, obtaining the relative absorption coefficients of one of the attenuated light beams with respect to the others from the Beer-Lambert law, and the type of the anesthetic gas will then be determined in accordance with the mapping position of said relative absorption coefficients in the coordinate system, which corresponds to said relative absorption coefficients.

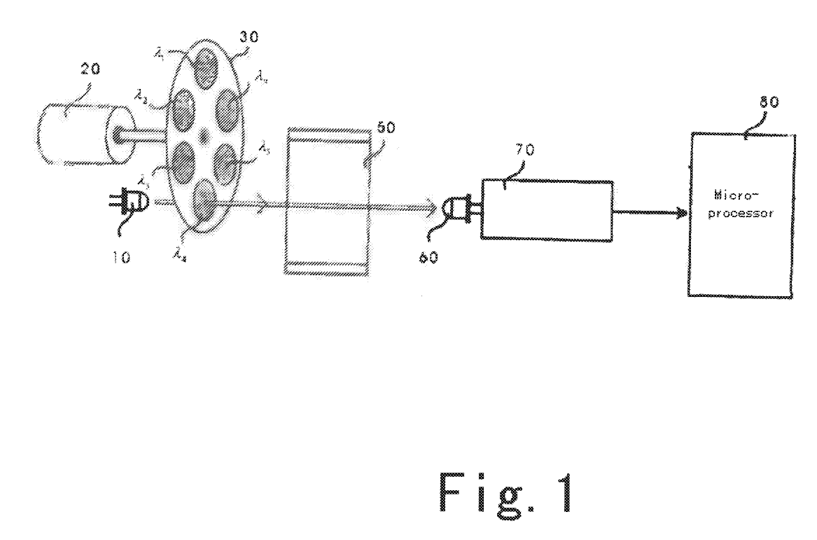

Hereinafter, an apparatus for detecting the type of anesthetic gas according to a preferred embodiment of the present invention will be firstly described with reference to FIG. 1.

As shown in FIG. 1, the apparatus for detecting the type of anesthetic gas according to the present invention, comprises: an infrared light source 10; a light filter wheel 30 provided with a plurality of light filters, wherein, the light filter wheel 30 may be driven to rotate by an electromotor 20, and the light beam filtered out by each of the light filters is a light beam having a central frequency and the bandwidth thereof within a predetermined range (the bandwidth Δλ is less than 200 nm, preferably less than 90 nm); a detection gas chamber 50 into which the anesthetic gas to be detected is injected, wherein, the infrared light of wide band generated by the light source 10 sequentially pass through the gas chamber 50 after having been filtered by the various light filters provided on the light filter wheel 30; an infrared light sensor 60 for respectively detecting the light intensities of various attenuated light beams transmitted through the gas chamber 50, wherein the attenuated light beams having been absorbed by the anesthetic gas; a signal amplifying processing circuit 70 to amplify the signals detected by the infrared light sensor 60; a microprocessor 80, which calculates the relative absorption coefficients of infrared light beams of a certain wavelength relative to the other infrared light beams with respect to the anesthetic gas based on the amplified signals, and then maps the calculated relative absorption coefficients into the coordinate system corresponding to said relative absorption coefficients, and eventually determines the type of the anesthetic gas in accordance with the mapping position of the relative absorption coefficients.

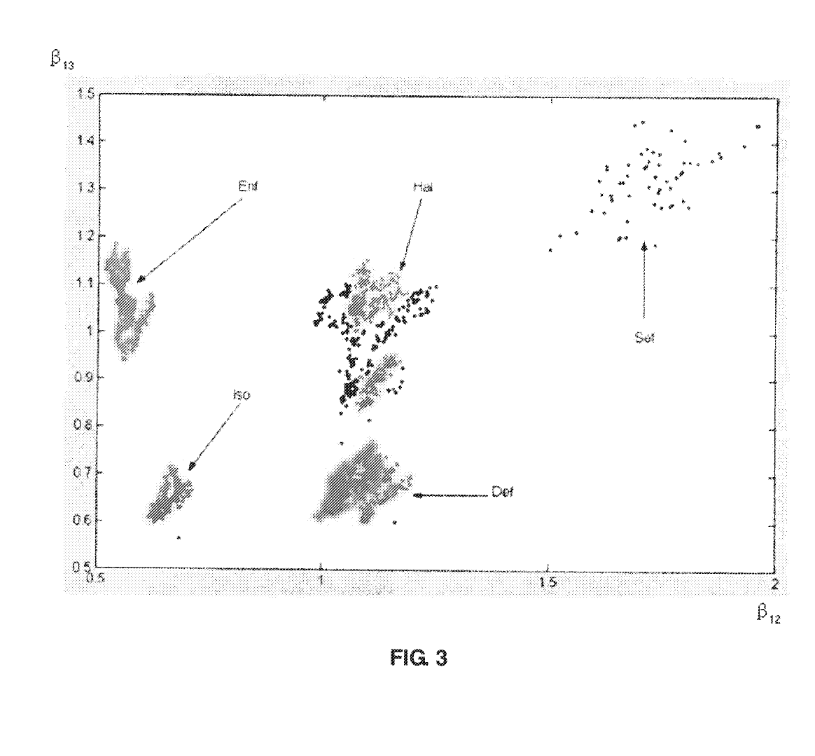

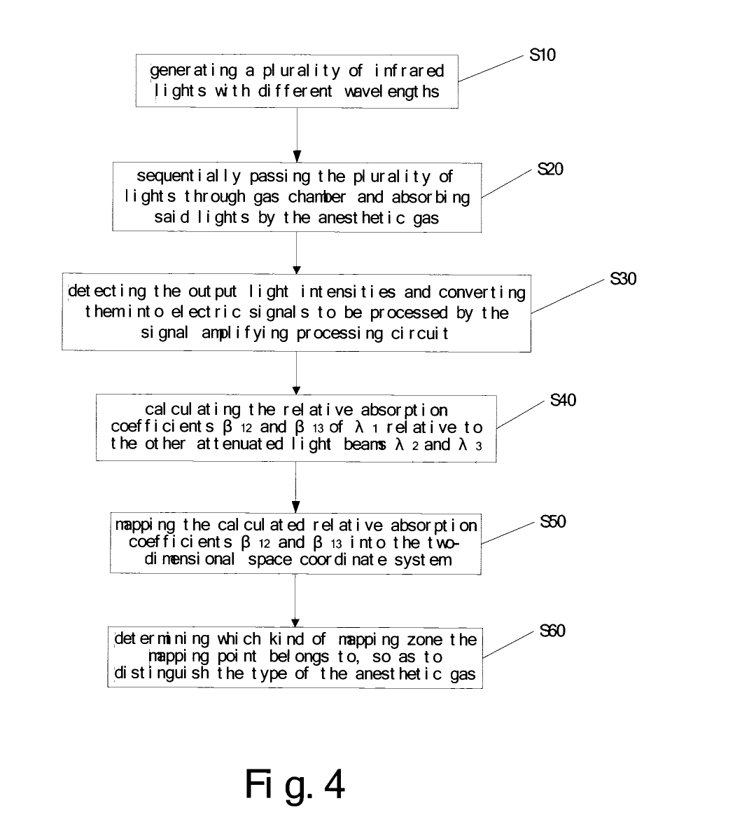

In the microprocessor 80 shown in FIG. 1, the method disclosed in Chinese Patent Application No.200510035266.0 (corresponding to the patent application Ser. No. 11/323,703) filed on Jun. 10, 2005 by the present applicant may be adopted as the above method for calculating the relative absorption coefficients, the content of which is hereby incorporated by reference into this application. In the description made below and in conjunction with FIG. 3, the coordinate system corresponding to the calculated relative absorption coefficients used when mapping the relative absorption coefficients will be described in detail. Further, the procedure of determining the type of the anesthetic gas by utilizing the coordinate system based upon the mapping position of the calculated relative absorption coefficients in the coordinate system will be described in detail hereinafter with reference to FIG. 4.

In the apparatus for detecting the type of anesthetic gas of the present invention shown in FIG. 1, when the light emitted by the infrared light source 10 is filtered by any one of the light filters on the light filter wheel 30, it is preferable that the above configuration components are disposed in such a manner that the axis of the infrared light source 10 passes through the center of the light filters and coincides with the axes of the detection gas chamber 50 and infrared light sensor 60, to improve the detection precision of the infrared light sensor 60.

In the embodiment of the present invention shown in FIG. 1, six light filters are provided on the light filter wheel 30, wherein, the infrared light beams λ₁ to λ₅, which are filtered by five light filters with wavelength 8.37 μm, 8.55 μm, 8.75 μm, 9.62 μm and 12.3 μm, all exhibit infrared light absorption effect when passing through five anesthetic gases (i.e. Desflurane, Isoflurane, Enflurane, Sevoflurane and Halothane) commonly used in current clinical medicine; while the infrared light beam which is filtered by another light filter with wavelength 10.5 μm exhibits substantially no infrared light absorption spectrum when passing through the five anesthetic gases.

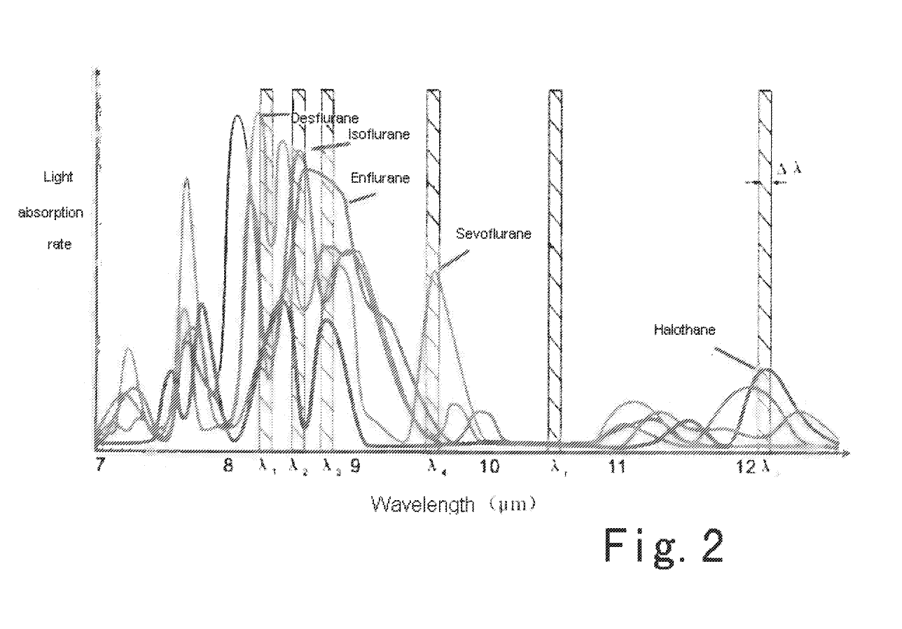

With reference to FIG. 2, where, λᵣ represents the infrared light beam which exhibits substantially no infrared light absorption spectrum. In the present invention, the light filter with wavelength λᵣ is provided to supply a reference light beam in the process of detecting the anesthetic gas, that is, the light intensity of the reference light beam which has been transmitted through the gas chamber 50 may be used as a reference for the light intensity of infrared light generate by the infrared light source 10 in real time, in order to perform calibration to the attenuated light beams transmitted through the gas chamber 50 which have been absorbed by the anesthetic gas, so that the detection precision is further improved.

In addition, the above apparatus for detecting the type of anesthetic gas of the present invention, as shown in FIG. 1, may further comprise a synchronization component, for synchronizing the detection of light intensities of the respective attenuated light beams. The synchronization component, for example, may be composed of a synchronization light source, a synchronization opening for light through which is provided on the light filter wheel 30 and a synchronization signal detection circuit. The synchronization signal detection circuit synchronize the detection of each light beam in each chop-wave period based upon synchronization signal monitoring, by receiving the light transmitted from the light source through the opening, so that it ensures that the respective light beams can be detected in each period and no error is accumulated, thereby ensuring the accuracy of measurement and judgment. By virtue of this synchronization component, it is possible to eliminate the light filtering delay due to the rotation speed of the light filter wheel, so that it is ensured that the infrared light sensor 60 may accurately detect the intensity of the attenuated light beams passing through the gas chamber that have been filtered by each light filter.

Hereinafter, a coordinate system constructed by utilizing the relative absorption coefficients will be first described in conjunction with FIG. 3, taking the apparatus for detecting the type of anesthetic gas of the present invention shown in FIG. 1 as an example.

In FIG. 1, when the infrared light beams which have been filtered by the respective light filters sequentially pass through the gas chamber into which one kind of anesthetic gas has been injected, the light intensities of the infrared light beams with wavelengths λ₁˜λ₅ will be attenuated after they pass through the chamber because the anesthetic gas exhibits infrared light absorption effect regarding to the infrared light beams λ₁˜λ₅. The relative absorption coefficients βₙₘ of any one of the attenuated light beams λₙ with respect to the other attenuated light beams may be obtained by detecting the light intensities of the various attenuated light beams transmitted through the gas chamber, wherein, 1≦n≦5, 1≦m≦5 and m≠n. For example, if n=1, the relative absorption coefficients of λ₁ with respect to the other attenuated light beams λ₂, λ₃, λ₄ and λ₅ maybe represented by β₁₂, β₁₃, β₁₄ and β₁₅.

Regarding to different types of anesthetic gases, the values of the relative absorption coefficients vary accordingly. Therefore, the type of the anesthetic gas may be determined by utilizing the relative absorption coefficients.

Specifically, two relative absorption coefficients can be selected arbitrarily to construct a two-dimensional space coordinate system. For example, in the above embodiment, β₁₂ is selected as the x-axis and β₁₃ is selected as the y-axis. In the two-dimensional space coordinate system, different types of anesthetic gases have different values of β₁₂ and β₁₃. In other words, each kind of anesthetic gas may be respectively mapped to a point in the coordinate system. For one kind of anesthetic gas, although the mapped points of the gas in the coordinate system may be slightly deviated from each other when it has different concentrations, a small mapping zone is generally formed with one mapping point as the center in the coordinate system. For the five anesthetic gases commonly used in current clinical medicine, i.e., Desflurane, Isoflurane, Enflurane, Sevoflurane and Halothane, they correspond to five mapping zones respectively, and the five zones are spaced apart from each other in a certain distances, as shown in FIG. 3.

When any anesthetic gas in the five gases is used in clinical medicine, the type of the anesthetic gas may be distinguished based on the mapping position determined by the relative absorption coefficients, which are obtained by detecting the light intensities of the various attenuated light beams transmitted through the gas chamber and then calculating the relative absorption coefficients of any one of the attenuated light beams with respect to the other attenuated light beams.

Certainly, three relative absorption coefficients can also be selected arbitrarily to construct a three-dimensional space coordinate system. For example, β₁₂ is selected as the x-axis, β₁₃ is selected as the y-axis, and β₁₄ is selected as the z-axis. Since different kinds of anesthetic gases have different mapping zones in the coordinate system, the type of the anesthetic gas can be determined based on the mapping position of the detected anesthetic gas in use in the three-dimensional coordinate system. Similarly, four relative absorption coefficients can also be selected arbitrarily to construct a four-dimensional space coordinate system, in order to determine the type of the anesthetic gas.

Hereinafter, a method for detecting the type of anesthetic gas of the present invention will be described in detail in conjunction with FIG. 4, utilizing the two-dimensional space coordinate system formed by β₁₂ and β₁₃ as noted above as an example.

At first, the light filter wheel 30 aligns the respective light filters with the infrared light source 10 in turn under the driving of the electromotor 20, so as to filter out a plurality of infrared light beams whose central frequencies correspond to different wavelengths (Step S10). In this embodiment, for the above-mentioned two-dimensional space coordinate system (β₁₂, β₁₃), the infrared light beams having wavelengths of λ₁, λ₂, λ₃ and λᵣ are selectively generated by the light filters.

The plurality of light beams sequentially pass through the gas chamber 50 injected with one kind of anesthetic gas; the anesthetic gas exhibits absorption effect to some extent with respect to the infrared light beams except the reference light beam of wavelength λᵣ (Step S20).

Next, the infrared light sensor 60 detects the light intensities of the various transmitted light beams from the detection gas chamber 50 respectively, and converts the light intensities of various transmitted light beams to electric signals so as to be provided to the signal amplifying processing circuit 70 (Step S30). Wherein, the transmitted light beams include the various attenuated infrared light beams that have been absorbed by the anesthetic gas, and the reference light beam that substantially has not been absorbed by the anesthetic gas.

After the amplifying process performed by the signal amplifying processing circuit 70, the microprocessor 80 calculates the relative absorption coefficients β₁₂ and β₁₃ of light beam λ₁ with respect to the other attenuated light beams λ₂ and λ₃ based on the detected light intensities of the various attenuated light beams (Step S40). Then, the calculated relative absorption coefficients β₁₂ and β₁₃ are mapped into the two-dimensional space coordinate system (Step S50). Next, it is determined that which kind of mapping zone the mapping point belongs to, so as to distinguish the type of the anesthetic gas (Step S60). In the step S60, the type of the anesthetic gas may also be determined by calculating the distances between the mapping point and a reference point in each mapping zone of the various anesthetic gases, and selecting the nearest mapping zone as the zone that the mapping point belongs to.

When selecting the above reference point in each mapping zone, the central point of each mapping zone may be selected as the reference point. Alternatively, it can be particularly selected based on the mapping zone of the anesthetic gas. For example, in the two-dimensional space coordinate system constructed by certain relative absorption coefficients, the mapping zone of Halothane overlaps with that of the other four anesthetic gases to some extent. In this case, it is preferred to select an appropriate point instead of the central point as the reference point, in order to prevent the mapping point belonging to the mapping zone of Halothane from being sorted into the mapping zones of the other anesthetic gases.

Finally, after the type of the anesthetic gas is determined, the microprocessor 80 may further output the information regarding the type of the anesthetic gas. Thereby, a conventional display may display the type of the detected anesthetic gas to the physician to assist his operation in the therapy procedure.

Certain advantageous effects provided by embodiments of the invention will now be described.

The method and apparatus for detecting the type of anesthetic gas according to the present invention determines the type of the anesthetic gas by utilizing the specific mapping zones of respective anesthetic gases in the coordinate system corresponding to the relative absorption coefficients. Thus, it is not necessary to obtain the concentration of the gas in the present invention, so that the procedure of solving the non-linear matrix equation is avoided and the particular design for the light filters is no longer necessary, as a result, the complexity and cost of the apparatus is further reduced.

In addition, when a three-dimensional or multi-dimensional space coordinate system is adopted, not only the type of the anesthetic gas can be simply determined, but also the concentration information and the like can be further obtained by calculation, for providing the medical diagnostic procedure with more assistant information.

In practical application, the technical solution disclosed by the invention may be freely applied and adaptively modified according to the requirement.

For example, the step of calculating the relative absorption coefficients between various attenuated infrared light beams based on the light intensities of various attenuated infrared light beams detected and determining the type of the anesthetic gas performed by the microprocessor 80 may be implemented by software, or it may be implemented by hardware or further in a manner that the software and hardware are combined.

Moreover, in the embodiment of the present invention, the type of the anesthetic gas may be detected by utilizing the infrared spectrum absorption characteristic of the anesthetic gas, and it also may be detected by utilizing the spectrum absorption characteristic of the anesthetic gas in other wave bands.

While the present invention utilizes a light filter wheel provided with light filters to filter out a plurality of light beams whose central frequencies correspond to different wavelengths, it is also possible to directly use independent light sources which generate various light beams of different wavelengths to achieve this purpose.

Furthermore, the light filter wheel adopted in the present invention may be disposed in front of the gas chamber, to sequentially pass the various attenuated light beams corresponding to the various light filters through the gas chamber, so that the sensor can perform detection with respect to the light intensities of various attenuated light beams transmitted through the gas chamber respectively; the light filter wheel may also be disposed following the gas chamber, to sequentially filter the plurality of attenuated light beams which have passed through the gas chamber, so that the sensor is capable of detecting the light intensities of various attenuated light beams respectively.

In addition, the light filter wheel provided with a plurality of light filters in the present invention may also be replaced by a carrier that is capable of being provided with a plurality of light filters.

While the present invention utilizes the relative absorption coefficient to determine the type of the anesthetic gas detected, it is also possible to determine the type of the anesthetic gas on the basis of other absorption characteristics.

It should be understood by the skilled persons in the art, many modifications and changes might be made to the method and apparatus for detecting the type of anesthetic gas disclosed above by the present invention without departing from the contents of the invention. Accordingly, the protection scope of the present invention is defined by the claims.

Although the present invention has been described in connection with the preferred embodiment, it is not intended to be limited to the specific form set forth herein. Rather, the scope of the present invention is limited only by the accompanying claims. In the claims, the term “comprising” does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous.

What is claimed is:

1. A method for detecting the type of anesthetic gas, comprising the steps of:
(a) passing a plurality of light beams through a gas chamber injected with said anesthetic gas, wherein, said anesthetic gas has respective absorption characteristic with respect to each light beam;
(b) detecting the light intensities of the attenuated light beams absorbed by the anesthetic gas, respectively, to obtain the relative absorption coefficients of one of the attenuated light beams with respect to the others;
(c) mapping the obtained relative absorption coefficients into a coordinate system, which corresponds to said relative absorption coefficients; and
(d) determining the type of said anesthetic gas based on the mapping position of said relative absorption coefficients in the coordinate system.

2. A method according to claim 1, wherein, said plurality of light beams comprises at least three light beams with different central frequencies.

3. A method according to claim 1, wherein, the dimensionality of said coordinate system depends on the number of said relative absorption coefficients.

4. A method according to claim 1, wherein, different types of anesthetic gases have different mapping zones in said coordinate system, each mapping zone is respectively designated with a reference point, and the step (d) comprises:
calculating the distances between the mapping point and the respective reference points; and
determining the type of said anesthetic gas according to said distances.

5. A method according to claim 1, wherein, different types of anesthetic gases have different mapping zones in said coordinate system, and the step (d) comprises determining the type of said anesthetic gas based on which mapping zone the mapping point belongs to.

6. A method according to claim 4, wherein, the mapping zone of each type of anesthetic gas is formed by the mapping positions of the anesthetic gas with different concentrations in said coordinate system.

7. A method according to claim 5, wherein, the mapping zone of each type of anesthetic gas is formed by the mapping positions of the anesthetic gas with different concentrations in said coordinate system.

8. A method according to claim 2, further comprising the step of filtering said plurality of light beams by utilizing a plurality of light filters corresponding to said central frequencies, in order to sequentially pass the light beams each corresponding to said respective light filters through said gas chamber.

9. A method according to claim 2, further comprising the step of filtering said plurality of light beams having passed through said gas chamber utilizing a plurality of light filters corresponding to said central frequencies respectively, in order to separately detect the respective attenuated light beams corresponding to said respective light filters.

10. A method according to claim 2, wherein, the wavelengths corresponding to said central frequencies comprise at least three of 8.37 μm, 8.55 μm, 8.75 μm, 9.62 μm and 12.3 μm, and said anesthetic gas comprises at least one of the Desflurane, Isoflurane, Enflurane, Sevoflurane and Halothane.

11. A method according to claim 10, wherein, said relative absorption coefficients are the relative absorption coefficients of light beam with wavelength 8.37 μm relative to the light beams with wavelengths 8.55 μm and 8.75 μm.

12. A method according to claim 1, further comprising the steps of:
generating a reference light beam;
passing the reference light beam through said gas chamber injected with said anesthetic gas, wherein, said anesthetic gas substantially exhibits no absorption characteristic with respect to said reference light wave;
calibrating said light intensity of said attenuated light beams transmitted through said gas chamber by utilizing said reference light beam as a reference.

13. A method according to claim 1, further comprising the step of synchronizing the detection of the light intensities of the respective attenuated light beams.

14. An apparatus for detecting the type of anesthetic gas, comprising:
a gas chamber, to which said anesthetic gas is injected, wherein, said anesthetic gas have absorption characteristic with respect to each of said plurality of light beams having passed through said gas chamber;
a detecting unit, operative to detect the light intensities of the attenuated light beams transmitted through the gas chamber and absorbed by the anesthetic gas, respectively, to obtain the relative absorption coefficients of one of the attenuated light beams with respect to the others;
a mapping unit, operative to map the obtained relative absorption coefficients into a coordinate system, which corresponds to said relative absorption coefficients; and
a determining unit, operative to determine the type of said anesthetic gas based on the mapping position of said relative absorption coefficients.

15. An apparatus according to claim 14, wherein, said plurality of light beams comprises at least three light beams with different central frequencies.

16. An apparatus according to claim 14, wherein, the dimensionality of said coordinate system depends on the number of said relative absorption coefficients.

17. An apparatus according to claim 14, wherein, different types of anesthetic gases have different mapping zones in said coordinate system, each mapping zone is respectively designated with a reference point, and the determining unit is further operative to calculate the distances between the mapping point and the respective reference points and determines the type of said anesthetic gas according to said distances.

18. An apparatus according to claim 14, wherein, different types of anesthetic gases have different mapping zones in said coordinate system, and the determining unit determines the type of said anesthetic gas based on which mapping zone the mapping point belongs to.

19. An apparatus according to claim 17, wherein, the mapping zone of each type of anesthetic gas is formed by the mapping positions of the anesthetic gas with different concentrations in said coordinate system.

20. An apparatus according to claim 18, wherein, the mapping zone of each type of anesthetic gas is formed by the mapping positions of the anesthetic gas with different concentrations in said coordinate system.

21. An apparatus according to claim 15, further comprising a plurality of light filters corresponding to said central frequencies for filtering said plurality of light beams, in order to sequentially pass the light beams each corresponding to said respective light filters through said gas chamber.

22. An apparatus according to claim 15, further comprising a plurality of light filters corresponding to said central frequencies for filtering said plurality of light beams having passed through said gas chamber utilizing respectively, in order to separately detect the respective attenuated light beams corresponding to said respective light filters.

23. An apparatus according to claim 15, wherein, the wavelengths corresponding to said central frequencies comprise at least three of 8.37 μm, 8.55 μm, 8.75 μm, 9.62 μm and 12.3 μm, and said anesthetic gas comprises at least one of the Desflurane, Isoflurane, Enflurane, Sevoflurane and Halothane.

24. An apparatus according to claim 23, wherein, said relative absorption coefficients are the relative absorption coefficients of light beam with wavelength 8.37 μm relative to the light beams with wavelengths 8.55 μm and 8.75 μm.

25. An apparatus according to claim 21, further comprising a synchronization module for synchronizing the detection of the light intensities of the respective attenuated light beams.

26. An apparatus according to claim 22, further comprising a synchronization module for synchronizing the detection of the light intensities of the respective attenuated light beams.

27. An apparatus according to claim 25, wherein, said synchronization module comprises:
a light source;
an opening for light through which is located on the carrier provided with said plurality of light filters;
a detecting module, for receiving the light transmitted through the opening from the light source and controlling the plurality of light filters to sequentially filter the plurality of light beams so as to synchronize the detection of the light intensities of the respective attenuated light beams.

28. An apparatus according to claim 14, further comprising:
a component for generating a reference light beam, so that said light intensities of said attenuated light beams transmitted through said gas chamber can be calibrated by utilizing said reference light beam as a reference, wherein, said anesthetic gas substantially exhibits no absorption characteristic with respect to said reference light wave.
